(19) United States
(12) Patent Application Publication
(10) Pub. No.: US 2021/0088049 A1
(43) Pub. Date: Mar. 25, 2021

(54) VACUUM PUMP SYSTEM

(71) Applicant: Leybold GmbH, Köln (DE)

(72) Inventor: Robert Alois SCHNEIDERS, Neunkirchen-Seelscheid (DE)

(73) Assignee: Leybold GmbH, Boulogne-Billancourt (FR)

(21) Appl. No.: 16/772,318

(22) PCT Filed: Jan. 2, 2019
(86) PCT No.: PCT/EP2019/050040

§ 371 Date: Jun. 12, 2020

(30) Foreign Application Priority Data
Jan. 18, 2018 (DE) 20 2018 000 285.2

(51) Int. Cl. F04D 19/04; F04C 25/02; F04C 18/12

(52) U.S. Cl. CPC F04D 19/044; F04D 19/042; F04C 2220/10; F04C 18/126; F04C 25/02

(57) ABSTRACT

A vacuum pump system having at least two chambers which are arranged in series. A turbomolecular pump is connected to the second or final chamber, and a multistage Roots pump is connected to the first chamber, wherein the outlet of the first chamber is connected to an intermediate inlet of the multistage vacuum pump, and an outlet of the turbomolecular pump is connected to a main inlet of the multistage vacuum pump.

### BACKGROUND

### 1. Field of the Disclosure

The disclosure relates to a vacuum pump system.

### 2. Discussion of the Background Art

Vacuum pump systems with a plurality of vacuum pumps, such as in particular turbomolecular pumps and Holweck pumps, as well as booster pumps which may e.g. be claw pumps or Roots pumps, are known for use with mass spectrometers, for example. Mass spectrometers comprise a plurality of chambers connected in series with each other. Using the vacuum pumps, different vacuums are generated in the chambers, wherein the pressure decreases from a first chamber, into which a medium to be examined is introduced, towards the last chamber. The last chamber of a mass spectrometer, in which the lowest pressure prevails, is typically connected with a turbomolecular pump. The penultimate chamber is also connected with a turbomolecular pump, wherein the outlet of the turbomolecular pump connected with the last chamber is connected with the inlet of the turbomolecular pump of the penultimate chamber. This may be continued in a corresponding manner depending on the number of chambers, while its is also known to design the individual turbomolecular pumps as turbomolecular stages of a multi-stage vacuum pump. The first chamber in which the comparatively highest pressure prevails is connected with a pre-vacuum pump. Further, the outlet of the pump of the second chamber is also connected with the inlet of this pump. Such a vacuum pump system is described for example in WO 2006/048602.

Another vacuum pump system is described in WO 2006/048602, in which the first chamber is connected with two pre-vacuum pumps. These two pre-vacuum pumps are arranged in series and are connected with the first chamber. The outlet of the vacuum pump connected with the second chamber is connected either with the inlet of the first pre-vacuum pump or with the inlet of the second pre-vacuum pump.

In particular with mass spectrometers, it is required that the gas quantity supplied into the first chamber can be increased. Thereby, it is possible in particular to perform a more accurate and/or faster detection of a specific gas or a more accurate and/or faster examination of the gases introduced into the first chamber. However, when supplying a larger gas quantity, there is a problem that the vacuum pumps, in particular the molecular pumps, heat up significantly. This is disadvantageous since the mass spectrometer is thermally sensitive.

It is an object of the disclosure to provide a vacuum pump system which is in particular suited for use with mass spectrometers and with which also larger gas quantities can be examined.

### SUMMARY

The vacuum pump system of the disclosure comprises at least two chambers connected in series with each other. Preferably, these are chambers of a mass spectrometer. The second or last chamber is connected with a vacuum pump which preferably is a turbomolecular pump. The first chamber is connected with a multi-stage vacuum pump which preferably is an in particular two-stage Roots pump. In a mass spectrometer the first chamber is the chamber into which the gas to be examined is introduced. The second and each further chamber adjoins the first chamber in series, with a lower pressure prevailing in the second chamber than in the first chamber and a lower pressure prevailing in each further chamber than in the preceding chamber, respectively. According to the disclosure, an outlet of the vacuum pump which is connected with the second chamber is connected with a main inlet of the multi-stage vacuum pump. Furthermore, according to the disclosure, an outlet of the first chamber is connected with an intermediate inlet of the multi-stage vacuum pump. In this manner it is possible, according to the disclosure, to avoid a thermal load on the pumps and also a thermal load on a thermally sensitive mass spectrometer even when larger gas quantities are introduced into the first chamber of the vacuum pump system.

If the vacuum pump system comprises a third chamber, the same is also connected with a vacuum pump, in particular a turbomolecular pump. The outlet of this vacuum pump is connected with the inlet of the vacuum pump connected with the second chamber. The gas pumped from the third chamber thus flows through the vacuum pump connected with the third chamber, the vacuum pump connected with the second chamber and both stages of the multi-stage vacuum pump connected with the first chamber.

In a vacuum system having a fourth chamber, the fourth chamber is connected with a further vacuum pump, in particular a turbomolecular pump. The outlet of the latter is in turn connected with the inlet of the vacuum pump connected with the third chamber. Analogously, the vacuum pump system may also comprise further chambers.

The vacuum pumps respectively connected with the second and/or the third and/or the fourth or a further chamber are preferably designed as turbomolecular pumps or as Holweck pumps. It is particularly preferred that the vacuum pumps of adjacent chambers are designed as stages of a multi-inlet vacuum pump. In particular the vacuum pumps connected with the second, third and possibly a further chamber are, in a preferred embodiment, designed as a multi-inlet vacuum pump. In a system with four chambers it is preferred to connect a multi-inlet vacuum pump with the second, third and fourth chamber. In a preferred embodiment, the multi-inlet pump has a turbomolecular pump as the first and second stages and a Holweck pump as the third stage. Here, the fourth chamber is connected with the first stage so that gas pumped from the fourth chamber is conveyed through all three stages of the multi-inlet vacuum pump.

The third chamber is then connected with the second stage so that the gas pumped from the third chamber is pumped through the second and third stages of the multi-inlet pump. The second chamber is then connected only with the third stage so that this gas is pumped only through the third stage which is in particular designed as a Holweck pump. The outlet of the multi-inlet vacuum pump is in turn connected with the main inlet of the multi-stage vacuum pump connected with the first chamber.

In a particularly preferred embodiment, the multi-stage vacuum pump connected with the first chamber is a multi-stage pre-vacuum pump with access to a further stage, in particular the second stage. A two-stage Roots pump is particularly preferred.

### BRIEF DESCRIPTION OF THE DRAWINGS

The disclosure will be described hereinafter in more detail with reference to preferred embodiments and to the accompanying drawings.

In the Figures:

FIG. 1 is a schematic sketch of a first embodiment,

FIG. 2 is a schematic sketch of a second embodiment and

FIG. 3 is a schematic sketch of a third embodiment.

### DETAILED DESCRIPTION OF THE PREFERRED EMBODIMENT

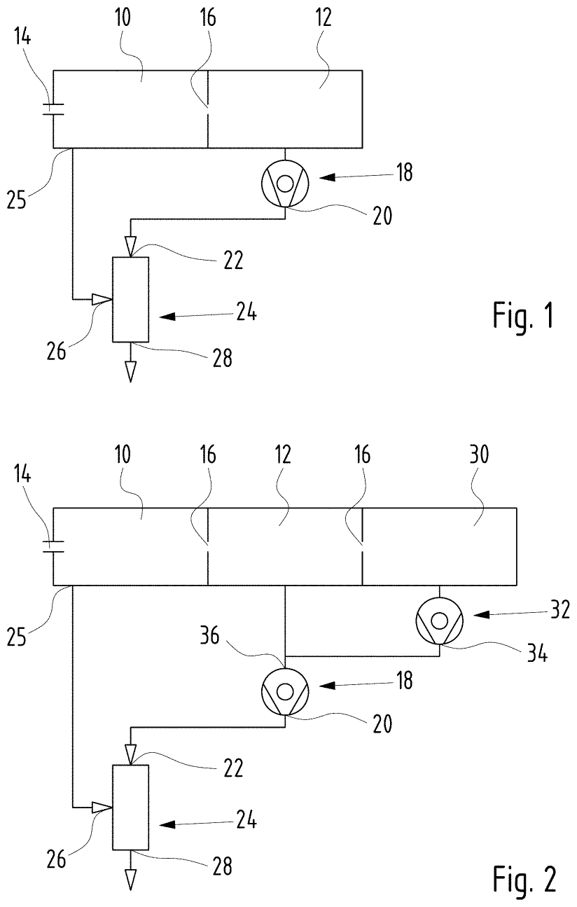

The vacuum pump system of the disclosure according to a first embodiment (FIG. 1) has two chambers 10, 12 which may be chambers of a mass spectrometer. The first chamber 10 has an inlet 14 for the supply of a gas to be examined. The gas flows from the chamber 10 through an opening 16 into the second chamber 12. The second chamber 12 is connected with a vacuum pump 18 which may be a turbomolecular pump. An outlet 20 of the vacuum pump 18 is connected with a main inlet 22 of a two-stage vacuum pump 24.

The vacuum pump 24 is a two-stage Roots pump. An outlet 25 of the first chamber 10 is connected with an intermediate inlet 26 of the multi-stage vacuum pump 24. An outlet 28 of the multi-stage vacuum pump 24 is connected with the environment, it being possible, of course, to provide a filter or the like.

In the embodiment illustrated in FIG. 2 similar or identical components are identified by the same reference numerals as in FIG. 1.

In addition to the two chambers 10, 12, this embodiment comprises a third chamber 30. The third chamber 30 is connected with a further turbomolecular pump 32. An outlet 34 of the turbomolecular pump 32 is connected with an inlet 36 of the turbomolecular pump 18. The inlet 36 of the turbomolecular pump 18 is further connected with the chamber 12. Moreover, the turbomolecular pump 18, as well as the chamber 10 are connected with the multi-stage vacuum pump 24 in a manner analogous to the embodiment illustrated in FIG. 1.

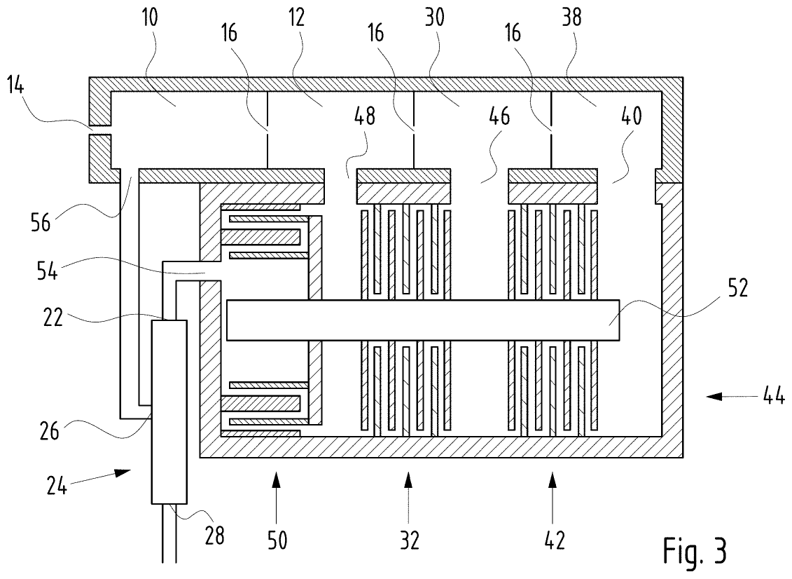

In the further embodiment illustrated in FIG. 3 similar or identical components are identified by the same reference numerals.

In addition to the three chambers 10, 12, 30, the embodiment illustrated in FIG. 3 comprises a further chamber 38 also arranged in series. The pressure prevailing in the chambers decreases from the chamber 10 to the chamber 38. The chambers are in turn connected with each other via openings 16. An outlet 40 of the chamber 38 is connected with a turbomolecular pump 42 which is a turbomolecular pump stage of a multi-inlet pump 44.

An outlet 46 of the chamber 30 is connected with the turbomolecular pump 32 in a manner corresponding to the embodiment illustrated in FIG. 2. The turbomolecular pump 32 is designed as a further turbomolecular pump stage of the multi-inlet pump 44.

The outlet 48 of the second chamber 12 is also connected with the multi-inlet pump 44. The gas pumped from the second chamber 12 is conveyed via a pump stage 50 designed as a Holweck pump in the embodiment illustrated. The pump stage 50 is analogous to the turbomolecular pump 18 in the embodiments in FIGS. 1 and 2.

The three pump stages 42, 32, 50 are driven by a common shaft 52 of the multi-inlet pump 44.

An outlet 54 of the multi-inlet pump 44 is connected with the main inlet 22 of the two-stage Roots pump 24 in a manner analogous to the embodiments illustrated in FIGS. 1 and 2. In analogy, an inlet 56 is connected with the intermediate inlet 26 of the two-stage Roots pump 24.

What is claimed is:

1. Vacuum pump system comprising
at least two chambers connected with each other in series,
a vacuum pump connected with the second chamber and
a multi-stage vacuum pump connected with the first chamber,
wherein an outlet of the vacuum pump is connected with a main inlet of the multi-stage vacuum pump and an outlet of the first chamber is connected with an intermediate inlet of the multi-stage vacuum pump.

2. Vacuum pump system of claim 1, wherein a third chamber is connected with a vacuum pump whose outlet is connected with the inlet of the vacuum pump connected with the second chamber.

3. Vacuum pump system of claim 2, wherein a fourth chamber is connected with a vacuum pump whose outlet is connected with the inlet of the vacuum pump connected with the third chamber.

4. Vacuum pump system of claim 1, wherein the vacuum pump connected with the second and/or third and/or fourth chamber is designed as a turbomolecular pump or a Holweck pump.

5. Vacuum pump system of claim 1, wherein the vacuum pumps of adjacent chambers are designed as stages as a multi-inlet vacuum pump.

6. Vacuum pump system of claim 5, wherein the last stage of the multi-inlet vacuum pump, seen in the flow direction, is designed as a Holweck stage.

7. Vacuum pump system of claim 6, wherein the stages arranged upstream of the last stage in the flow direction are designed as turbomolecular pump stages.

8. Vacuum pump system of claim 1, wherein the multi-stage vacuum pump is designed as a two-stage Roots pump.

9. Vacuum pump system of claim 1, wherein a lower pressure can be achieved in the second chamber than in the first chamber.

10. Vacuum pump system of claim 9, wherein in each chamber a lower pressure can be achieved than in the preceding chamber.
